(19) United States
(12) Patent Application Publication
(10) Pub. No.: US 2025/0229836 A1
(43) Pub. Date: Jul. 17, 2025

(54) UNDERBODY OF A VEHICLE

(71) Applicants: HYUNDAI MOTOR COMPANY, Seoul (KR); KIA CORPORATION, Seoul (KR)

(72) Inventors: Seung Min Jeong, Hwaseong-si (KR); Joo Nam Kim, Seoul (KR)

(73) Assignees: HYUNDAI MOTOR COMPANY, Seoul (KR); KIA CORPORATION, Seoul (KR)

(21) Appl. No.: 18/735,323

(22) Filed: Jun. 6, 2024

(30) Foreign Application Priority Data
Jan. 11, 2024 (KR) 10-2024-0005044

(51) Int. Cl. B62D 21/15; B23K 9/16; B23K 20/12; B60L 50/64; B60N 2/005; B62D 25/20; B62D 27/02; H01M 50/242; H01M 50/249

(52) U.S. Cl. CPC B62D 21/157; B23K 9/16; B23K 20/122; B60N 2/005; B62D 25/20; B62D 27/023; H01M 50/242; H01M 50/249; B60L 50/64; H01M 2220/20

(57) ABSTRACT

An underbody of a vehicle includes: a floor member formed through extrusion to extend in a width direction of the vehicle. The floor member is provided in plural such that a plurality of floor members is continuously disposed to be adjacent to one another in a longitudinal direction of the vehicle. Upper surfaces of the floor members constitute a floor of the vehicle, and lower surfaces of the floor members constitute an upper battery case. The underbody further includes first welding areas each formed in a boundary area between the lower surfaces of adjacent ones of the floor members, to interconnect the adjacent floor members. The first welding areas are formed through friction stir welding and extend in the width direction of the vehicle.

### CROSS-REFERENCE TO THE RELATED APPLICATION

This application claims priority to Korean Patent Application No. 10-2024-0005044, filed on Jan. 11, 2024 in the Korean Intellectual Property Office, the disclosure of which is incorporated herein by reference in its entirety.

### BACKGROUND

### 1. Field

The present disclosure relates to an underbody of a vehicle, and more particularly to a floor of a vehicle body constituting a lower part of a vehicle.

### 2. Description of the Related Art

In an electric vehicle, an increase in driving range is an important development target. To enhance the driving range of an electric vehicle, strategies include augmenting battery capacity by increasing the number of battery cells and reducing the weight of electric vehicle parts, etc. Increasing the battery capacity by merely adding more battery cells inevitably results in added weight from the added battery cells, thereby limiting the potential improvement in the driving range.

As such, many manufacturers are concentrating on a scheme for lightening a battery system itself or reducing the weight of a vehicle while mounting a maximum number of battery cells by maximally efficiently utilizing a limited vehicle space.

Meanwhile, a battery of an electric vehicle is generally mounted at a lower part of a vehicle body. In detail, the battery is mounted at the lower part of the vehicle body by interconnecting a plurality of battery modules, accommodating the battery modules in battery case, and mounting the battery case to the lower part of the vehicle body under the vehicle body. Development is underway on technology that allows a vehicle body floor to function as an upper battery case, provided that battery modules are accommodated in a lower battery case, thus eliminating the need for a separate upper battery case.

The above matters disclosed in this section are provided merely to enhance understanding of the general background of the disclosure and should not be taken as an acknowledgement or any form of suggestion that the matters form the related art already known to a person having ordinary skill in the art.

### SUMMARY

The present disclosure has been made in view of the above problems, and it is an object of the present disclosure to provide a coupling structure of a floor member formed through extrusion thereof in a width direction of a vehicle and provided in plural such that a plurality of floor members is continuously disposed to be adjacent to one another in a longitudinal direction of the vehicle. Upper surfaces of the floor members constitute a floor of the vehicle, and lower surfaces of the floor members constitute an upper battery case.

In accordance with an aspect of the present disclosure, the above and other objects can be accomplished by the provision of an underbody of a vehicle including a floor member formed through extrusion to extend in a width direction of the vehicle. The floor member is provided in plural such that a plurality of floor members is continuously disposed to be adjacent to one another in a longitudinal direction of the vehicle. In particular, upper surfaces of the plurality of floor members constitute a floor of the vehicle, and lower surfaces of the plurality of floor members constitute an upper battery case. First welding areas are each formed in a boundary area between the lower surfaces of adjacent ones of the plurality of floor members such that the adjacent floor members are interconnected to each other. The first welding areas are formed through friction stir welding (FSW) and extend in the width direction of the vehicle.

One of the adjacent floor members may be upwardly partially recessed at one end thereof to be stepped, thereby forming a step, and the other of the adjacent floor members may be formed, at the other end thereof, with a flange extending to face the step formed at the one floor member. The step and the flange may surface-contact each other, thereby causing the lower surfaces of the adjacent floor members to be disposed on the same plane. The step and the flange may be welded to each other through the friction stir welding, thereby forming a corresponding one of the first welding areas.

The plurality of floor members may include a plurality of members formed through extrusion to have different heights, respectively.

A reinforcing barrier wall extending in the width direction of the vehicle may be provided, at an inside of each of the floor members, to divide an interior of the floor member into a plurality of closed cross-sections.

An additional reinforcing barrier wall may be provided, at the inside of the floor member at a position adjacent to the step or the flange, to provide support force against a welding pressure generated during friction stir welding.

The underbody may further include second welding areas each formed in a boundary area between the upper surfaces of adjacent ones of the plurality of floor members, such that the adjacent floor members are interconnected to each other. The second welding areas may be formed through metal inert gas (MIG) welding and may extend in the width direction of the vehicle.

The floor members may include a first member and a second member. The first member may have a height greater than a height of the second member.

The first member may be provided in plural such that a plurality of first members is continuously disposed in the longitudinal direction of the vehicle and is coupled to one another. The second member may be disposed outside the first members and is coupled to an outermost one of the first members.

A seat mounting part may be formed, at the upper surface of the first member, to mount a seat of the vehicle thereon.

The floor members may further include a third member and a fourth member each including a vertical barrier wall having a downwardly-extending end. The third member or the fourth member may be disposed outside the first member or the second member and may be coupled to the first member or the second member.

The vertical barrier walls formed at the third member and the fourth member may constitute a front barrier wall and a rear barrier wall of the upper battery case, respectively.

The first member may be upwardly partially recessed at one end thereof to be stepped, thereby forming a first step, and a first flange extending toward a floor member adjacent thereto may be formed at the other end of the first member. The second member may be upwardly partially recessed at one end thereof to be stepped, thereby forming a second step, and a second flange extending toward a floor member adjacent thereto is formed at the other end of the second member.

The first member may be provided in plural such that a plurality of first members is continuously disposed in the longitudinal direction of the vehicle. The first step of one of adjacent ones of the first members and the first flange of another one of the adjacent first members may be welded to each other through friction stir welding under a condition that the first step and the first flange surface-contact each other. The second step of the second member and the first flange of one of the first members adjacent thereto may be welded to each other through friction stir welding under a condition that the second step and the first flange surface-contact each other or the first step of another one of the first members and the second flange of the second member adjacent thereto may be welded to each other through friction stir welding under a condition that the first step and the second flange surface-contact each other.

The floor members may further include a third member and a fourth member each including a vertical barrier wall having a downwardly-extending end. The third member may be upwardly partially recessed at one end thereof to be stepped, thereby forming a third step, and the fourth member may be formed, at the other end thereof, with a fourth flange extending toward one of the floor members adjacent thereto.

The second member may be provided in plural. The third step of the third member and the second flange of one second member adjacent thereto may be welded to each other through friction stir welding under a condition that the third step and the second flange surface-contact each other. The fourth flange of the fourth member and the second step of another second member adjacent thereto may be welded to each other through friction stir welding under a condition that the fourth flange and the second step surface-contact each other.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 illustrates mounting of a battery at a lower side;

FIG. 2 illustrates a cross-section taken along line A-A′ in FIG. 1;

FIG. 3 illustrates upper surface of a floor according to an embodiment of the present disclosure;

FIG. 4 illustrates a cross-section of a floor member provided with an additional reinforcing barrier wall;

FIG. 5 is a cross-sectional view taken along line B-B′ in FIG. 3; and

FIG. 6 illustrates an upper surface of a floor provided with a seat mounting part.

### DETAILED DESCRIPTION

Hereinafter, embodiments of the present disclosure are described in detail with reference to the accompanying drawings, and the same or similar elements are designated by the same reference numerals regardless of the numerals in the drawings and redundant description thereof is omitted.

In the following description of the embodiments of the present disclosure, a detailed description of known functions and configurations incorporated herein are omitted when it may obscure the subject matter of the embodiments of the present disclosure. In addition, the embodiments of the present disclosure should be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

Although the terms “first”, “second”, etc. may be used herein to describe various elements, these elements should not be limited by these terms. These terms are only used to distinguish one element from another.

Unless clearly used otherwise, singular expressions include a plural meaning.

In this specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

When a component, device, element, or the like of the present disclosure is described as having a purpose or performing an operation, function, or the like, the component, device, or element should be considered herein as being “configured to” meet that purpose or to perform that operation or function.

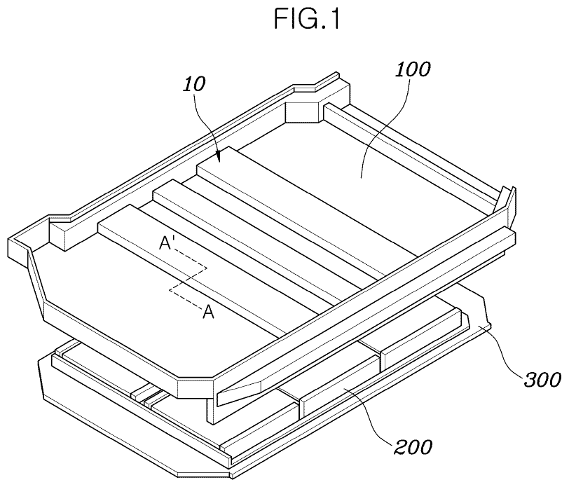

FIG. 1 shows mounting of a battery at a lower side. Referring to FIG. 1, a battery 200 is mounted to a lower portion of a floor 100 of a vehicle, taking into consideration of the center of gravity of the vehicle, driving stability of the vehicle, etc. because the weight of the battery 200 is a considerable factor of the weight of the vehicle.

In a conventional battery, battery modules thereof are mounted in a lower battery case, an upper battery case is coupled to the lower battery case, and the resultant structure (i.e., the assembled structure) is coupled to a vehicle body.

In an embodiment of the present disclosure, the separate configuration of an upper battery case is omitted, and instead, the floor 100 of the vehicle serves as the upper battery case, i.e., replacing the function of the omitted upper battery case, as shown in FIG. 1.

In other words, the floor 100 of the vehicle forms an inner space of the vehicle and provides a space for mounting a seat mounting part. In addition, a lower battery case 300, in which a battery is mounted or accommodated, may be coupled to the lower portion of the floor 100.

Because a battery is sensitive electronic equipment, the battery should be isolated from an external environment as much as possible. For this reason, in conventional cases, a sealer is coated on the battery: in order to block introduction of water or foreign matter from outside of the vehicle body.

However, the sealer is insufficient to secure airtightness and watertightness at a perfect level. In particular, the seal may have difficulty securing high-pressure watertight performance. In electric vehicles, achieving a perfect level of airtightness and watertightness is essentially. In particular, in the present disclosure in which an upper battery case is omitted, such a requirement is very great.

In order to secure airtightness and watertightness at a perfect level, the present disclosure proposes securing airtightness and watertightness through coupling of parts by welding while minimizing use of a sealer.

The floor of the vehicle in the present disclosure is not a single-plate type floor manufactured through a general pressing process, but is a floor having a closed cross-section manufactured through an extrusion process.

Conventionally, a single-plate type floor is manufactured using a set of molds configured to be easily adjustable in size. However, in the case of a floor manufactured through an extrusion process, extrusion is carried out under the condition that a billet is inserted into a mold. For this reason, there is a limitation on the extrusion size of the floor in a width direction of a vehicle.

For this reason, the floor 100 of the vehicle is manufactured by interconnecting a plurality of floor members 10 formed through extrusion thereof in a width direction of the vehicle.

Each floor member 10 may be molded by extruding aluminum or an alloy including aluminum. Accordingly, the floor member 10 has an upper surface and a lower surface. When a plurality of floor members 10 is coupled to one another in a state of being continuously disposed to be adjacent to one another in a longitudinal direction of the vehicle, upper surfaces thereof constitute the floor of the vehicle, and lower surfaces thereof constitute an upper battery case.

Hereinafter, a coupling structure for coupling floor members in order to secure airtightness and watertightness is described.

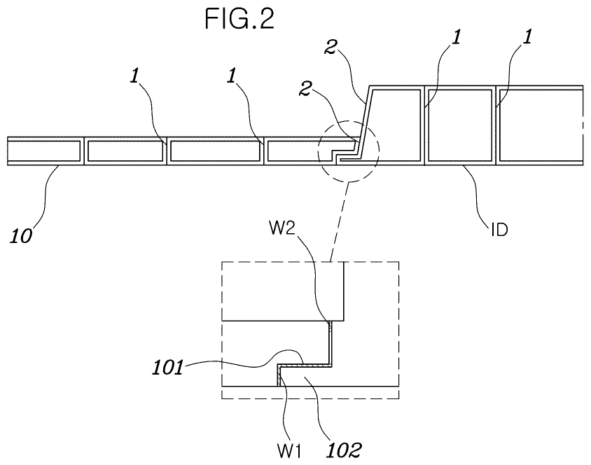

FIG. 2 shows a cross-section taken along line A-A′ in FIG. 1, i.e., a cross-section of a floor taken along line A-A′ in FIG. 1. Referring to FIG. 2, the floor is formed by coupling a plurality of floor members 10 to each other.

Adjacent ones of the plurality of floor members 10 are coupled to each other, and a position at which the adjacent floor members 10 are coupled to each other is a first welding area W1 formed in a boundary area between lower surfaces of the adjacent floor members 10. The first welding area W1 is formed through friction stir welding. As friction stir welding is carried out in a width direction of a vehicle, the first welding area W1 extends in the width direction of the vehicle.

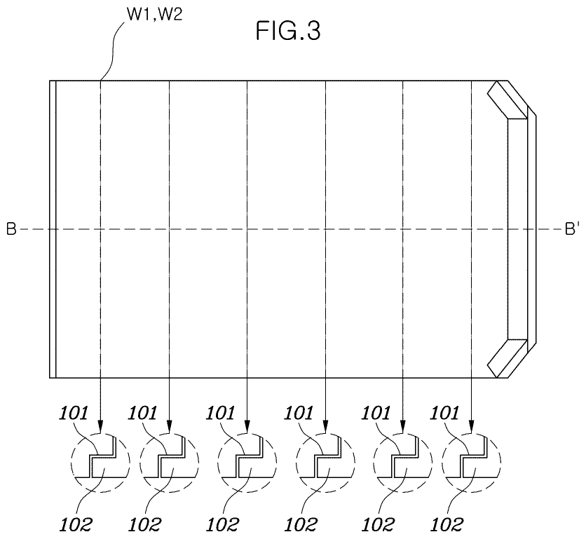

FIG. 3 shows an upper surface of the floor according to an embodiment of the present disclosure. Referring to FIG. 3, the first welding area W1 is formed in a boundary area between the adjacent floor members in the width direction of the vehicle.

In detail, as shown in FIGS. 2 and 3, each of the plurality of floor members 10 is upwardly partially recessed to be stepped, thereby forming a step 101, and is formed with a flange 102 extending to face the step 101 formed at another floor member 10 adjacent thereto.

In other words, the adjacent floor members 10 are disposed such that the step 101 formed at one of the adjacent floor members 10 and the flange 102 formed at the other of the adjacent floor members 10 face each other, and the flange 102 is then inserted into a space defined by the step 101 (e.g., under the step 101) such that the step 101 and the flange 102 surface-contact each other. Accordingly, lower surfaces of the adjacent floor members 10 are disposed on the same plane.

Thereafter, a friction stir welding machine performs friction stir welding while moving along the flange 102 and the step 101 extending in the width direction of the vehicle, thereby forming a first welding area W1. By virtue of the first welding area W1, the adjacent floor members 10 are coupled to each other.

In one embodiment, the plurality of floor members 10 may include a plurality of members formed through extrusion to have different heights. A part of the members may be formed to have a height greater than the remaining part of the members such that a seat mounting part, on which a seat will be mounted, is provided. Another part of the members may be formed to further extend downwardly than the remaining part of the members and, as such, may function as a barrier wall surrounding the battery 200.

As described above, floor members 10 having various heights may be manufactured, the step 101 and the flange 102 are formed at each floor member 10, and adjacent ones of the floor members 10 are coupled to each other through coupling between the step 101 or the flange 102 of one of the adjacent floor members 10 and the flange 102 or the step 101 of the other of the adjacent floor members 10. Thus, the floor 100 may be completed.

In another embodiment, reinforcing barrier walls 1 may be formed at an inside of each floor member 10, to extend in the width direction of the vehicle, such that an interior of the floor member 10 is divided into a plurality of closed cross-sections. When the floor member 10 is manufactured, a mold may be manufactured such that the reinforcing barrier walls 1 are disposed in the longitudinal direction of the vehicle.

As the reinforcing barrier walls 1 are disposed in the longitudinal direction of the vehicle, a plurality of closed cross-sections may be formed at the interior of the floor member 10, and the completed floor 100 may secure stiffness against lateral collision by the plurality of closed cross-sections.

In an embodiment, a pressure applied to the flange 102 during friction stir welding is substantially 6,500 N. For this reason, one side surface of the floor member 10 may be raised in a direction in which pressure is applied during friction stir welding.

However, since the step 101 and the flange 102 of the floor member 10 are formed at ends of the lower surface of the floor member 10, respectively, and vertical walls 2 are formed at ends of the floor member 10, respectively, to constitute a closed cross-section of the floor member 10, the walls 2 may sustain the pressure applied to the step 101 and the flange 102 during friction stir welding, thereby preventing one side surface of the floor member 10 from being raised.

Another reinforcing barrier wall 1 may be additionally provided at the inside of the floor member 10 at a position adjacent to the step 101 or the flange 102 in order to provide reliable support force against welding pressure generated during friction stir welding.

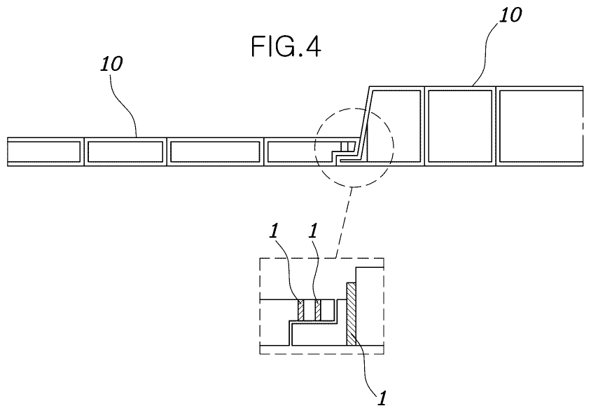

In other words, referring to FIG. 4, the additional reinforcing barrier wall 1 formed to extend in a direction in which the pressure generated during friction stir welding is applied are provided at a portion of the floor member 10 adjacent to the step 101 or the flange 102 and, as such, support force against the welding pressure may be secured.

Lower surfaces of the adjacent floor members 10 may secure airtightness and watertightness by the first welding area W1 formed through friction stir welding, and upper surfaces of the adjacent floor members 10 may be welded to each other through metal inert gas (MIG) welding, thereby achieving firm coupling of a plurality of floor members 10.

Referring to FIG. 2, a boundary area is formed between the upper surfaces of the adjacent floor members 10, and the adjacent floor members 10 may surface-contact each other in a direction perpendicular to the ground. However, it i difficult to weld insides of the floor members 10 through friction stir welding. For this reason, a second welding area W2 may be formed by welding the boundary area between the upper surfaces of the floor members 10 through MIG welding and, as such, firm coupling between the floor members 10 may be achieved.

Similar to the first welding area W1, the second welding area W2 also extends in the width direction of the vehicle. Consequently, it may be possible to not only secure watertightness and airtightness by coupling the floor members 10 to each other by the first welding area W1, but also to achieve firm coupling between the floor members 10 by the second welding area W2.

Since the plurality of floor members 10 may have different heights, as described above, the second welding area W2 may be formed at the upper surfaces of the floor members 10 through execution of MIG welding.

When the plural floor members 10 are coupled together through friction stir welding and MIG welding, as described above, airtightness and watertightness may be achieved. In addition, the floor 100 formed by the plurality of floor members 10 may secure sufficient stiffness against external collision.

In particular, as the plural floor members 10 are coupled together, a plurality of chambers capable of distributing external impact may be formed and, as such, it may be possible to protect the battery 200 from external impact.

In one embodiment, a side seal may be coupled to a side portion of the floor 100 in order to protect the battery 200 disposed at a side surface of the lower battery case 300 and to secure watertightness and airtightness at the side portion of the floor 100.

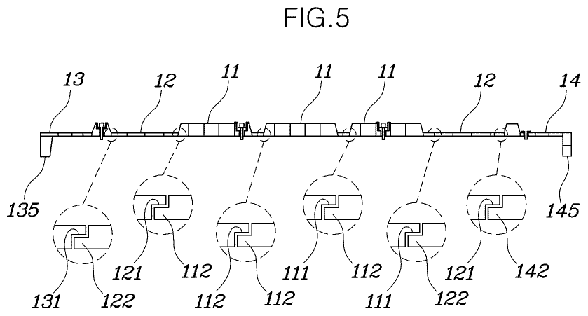

Hereinafter, an underbody of the vehicle according to an embodiment of the present disclosure is described in detail. FIG. 5 is a cross-sectional view taken along line B-B′ in FIG. 3.

As described above, the floor members 10 may include a plurality of members 11, 12, 13, and 14 formed through extrusion to have different heights.

In detail, the floor members 10 may include a first member 11, a second member 12, a third member 13, and a fourth member 14. Hereinafter, each member is described below.

The first member 11 may be disposed further inside the floor than the remaining members and may be continuously disposed in plural in the longitudinal direction of the vehicle such that a plurality of first members 11 is coupled to one another. In other words, the first member 11 may be located deeper within the floor than the other members and may be consistently arranged in multiples along the longitudinal direction of the vehicle. In this case, an outermost first member among the plurality of first members 11 may be coupled to the second member 12, and a middle first member among the plurality of first members 11 may be coupled to another one of the first members 11.

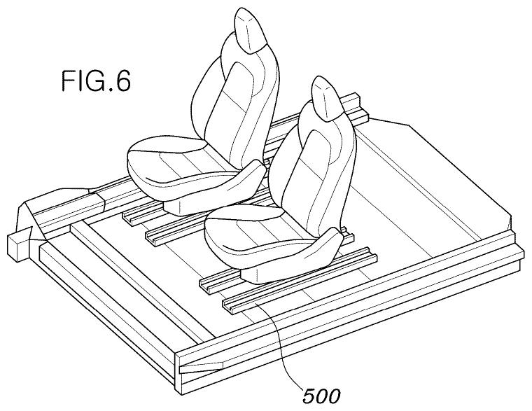

FIG. 6 illustrates a seat mounting part 500 on which a seat of the vehicle is mounted. In particular, the seat mounting part 500 may be formed at an upper surface of the first member 11. Accordingly, the first member 11 may be formed to have a height greater than that of the second member 12.

The third member 13 and the fourth member 14 may be disposed at a foremost end and a rearmost end of the floor 100, respectively. The third member 13 and the fourth member 14 may, in some cases, be coupled on the outer side of the first member 11 or on outer side of the second member 12.

The third member 13 and the fourth member 14 include respective vertical barrier walls 135 and 145 each having a downwardly-extending end. The vertical barrier walls 135 and 145 formed at the third member 13 and the fourth member 14 constitute a front barrier wall and a rear barrier wall of an upper battery case and thus may protect the battery 200 from external impact.

Hereinafter, coupling of the first to fourth members is described with reference to FIG. 5.

The first member 11 is upwardly partially recessed at one end thereof to be stepped and, as such, a first step 111 is formed. A first flange 112 extending toward a floor member adjacent thereto is formed at the other end of the first member 11. In addition, the second member 12 is upwardly partially recessed at one end thereof to be stepped and, as such, a second step 121 is formed. A second flange 122 extending toward a floor member adjacent thereto is formed at the other end of the second member 12.

Coupling between adjacent first members 11 is carried out as follows. The first flange 112 of one of the adjacent first members 11 and the first step 111 of the other of the adjacent first members 11 disposed adjacent to the first flange 112 are welded to each other through friction stir welding under the condition that the first flange 112 and the first step 111 surface-contact each other. Thus, the adjacent first members 11 are coupled to each other.

In this case, a boundary area between upper surfaces of the adjacent first members 11 is welded through MIG welding. Accordingly, coupling between the first members 11 may be firmly achieved.

Coupling between the first member 11 and the second member 12 is carried out as follows. The first flange 112 of the first member 11 and the second step 121 of the second member 12 disposed adjacent to the first flange 112 are welded to each other through the friction stir welding under the condition that the first flange 112 and the second step 121 surface-contact each other. Thus, the first member 11 and the second member 12 are coupled to each other.

In addition, the first step 111 of the first member 11 and the second flange 122 of the second member 12 disposed adjacent to the first step 111 are welded to each other through the friction stir welding under the condition that the first step 111 and the second flange 122 surface-contact each other. Thus, the first member 11 and the second member 12 are coupled to each other.

In this case, a boundary area between upper surfaces of the first member 11 and the second member 12 is welded through MIG welding. Accordingly, coupling between the first member 11 and the second member 12 may be firmly achieved.

Although each of the third member 13 and the fourth member 14 may be coupled to the first member 11, the following description is given in conjunction with the case in which each of the third member 13 and the fourth member 14 is coupled to the second member 12 in accordance with an embodiment of the present disclosure.

First, the third member 13 may be upwardly partially recessed at one end thereof to be stepped and, as such, a third step 131 may be formed. A fourth flange 142 extending toward a floor member adjacent thereto may be formed at the other end of the fourth member 14.

Coupling between the second member 12 and the third member 13 may be carried out as follows. The third step 131 of the third member 13 and the second flange 122 of the second member 12 disposed adjacent to the third step 131 are welded to each other through friction stir welding under the condition that the third step 131 and the second flange 122 surface-contact each other. Thus, the second member 12 and the third member 13 are coupled to each other.

In this case, a boundary area between upper surfaces of the second member 12 and the third member 13 is welded through the MIG welding. Accordingly, coupling between the second member 12 and the third member 13 may be firmly achieved.

Coupling between the second member 12 and the fourth member 14 may be carried out as follows. The fourth flange 142 of the fourth member 14 and the second step 121 of the second member 12 disposed adjacent to the fourth flange 142 are welded to each other through the friction stir welding under the condition that the fourth flange 142 and the second step 121 surface-contact each other. Thus, the second member 12 and the fourth member 14 are coupled to each other.

In this case, a boundary area between upper surfaces of the second member 12 and the fourth member 14 is welded through the MIG welding. Accordingly, coupling between the second member 12 and the fourth member 14 may be firmly achieved.

According to the present disclosure, the floor of the vehicle may also perform the function of an upper battery case. Accordingly, it may be possible to reduce the weight of the vehicle by the amount of weight eliminated due to the absence of the upper battery case.

In addition, airtightness and watertightness may be secured through the friction stir welding and MIG welding in order to prevent foreign matter from entering the battery.

Although the some embodiments of the present disclosure have been disclosed for illustrative purposes, those having ordinary skill in the art should appreciate that various modifications, additions and substitutions are possible, without departing from the scope and spirit of the disclosure as disclosed in the accompanying claims.

What is claimed is:

1. An underbody of a vehicle, comprising:
a plurality of floor members extending in a width direction of the vehicle and continuously disposed to be adjacent to one another in a longitudinal direction of the vehicle, wherein upper surfaces of the plurality of floor members constitute a floor of the vehicle, and lower surfaces of the plurality of floor members constitute an upper battery case; and
first welding areas each formed in a boundary area between the lower surfaces of adjacent ones of the plurality of floor members, wherein the first welding areas are configured to extend in the width direction of the vehicle and interconnect the adjacent floor members of the plurality of floor members.

2. The underbody according to claim 1, wherein:
one of the adjacent floor members is upwardly partially recessed at one end thereof to be stepped, thereby forming a step, and another one of the adjacent floor members is formed, at another end thereof, with a flange extending to face the step formed at the one floor member;
the step and the flange surface-contact each other, thereby causing the lower surfaces of the adjacent floor members to be disposed on a same plane; and
the step and the flange are welded to each other through friction stir welding, thereby forming a corresponding one of the first welding areas.

3. The underbody according to claim 1, wherein the plurality of floor members comprises a plurality of members formed through extrusion to have different heights, respectively.

4. The underbody according to claim 2, wherein a reinforcing barrier wall extending in the width direction of the vehicle is provided, at an inside of each of the floor members, to divide an interior of the floor member into a plurality of closed cross-sections.

5. The underbody according to claim 4, wherein an additional reinforcing barrier wall is provided, at an inside of the floor member at a position adjacent to the step or the flange, to provide support force against a welding pressure generated during friction stir welding.

6. The underbody according to claim 1, further comprising:
second welding areas each formed in a boundary area between the upper surfaces of adjacent ones of the plurality of floor members, wherein the second welding areas are formed through metal inert gas (MIG) welding and extend in the width direction of the vehicle to interconnect the adjacent floor members of the plurality of floor members.

7. The underbody according to claim 1, wherein:
the plurality of floor members comprise at least one first member and a second member; and
the at least one first member has a height greater than a height of the second member.

8. The underbody according to claim 7, wherein:
the at least one first member includes a plurality of first members continuously disposed in the longitudinal direction of the vehicle, wherein the plurality of first members are coupled to one another; and
the second member is disposed outside the plurality of first members and is coupled to an outermost first member among the plurality of first members.

9. The underbody according to claim 7, wherein a seat mounting part is formed at the upper surface of the at least on first member and configured to mount a seat thereon.

10. The underbody according to claim 7, wherein:
the plurality of floor members further comprises a third member and a fourth member each including a vertical barrier wall having a downwardly-extending end; and
the third member or the fourth member is disposed outside the at least one first member or the second member and is coupled to the at least one first member or the second member.

11. The underbody according to claim 10, wherein the vertical barrier walls formed at the third member and the fourth member constitute a front barrier wall and a rear barrier wall of the upper battery case, respectively.

12. The underbody according to claim 7, wherein:
the at least one first member is upwardly partially recessed at one end thereof to be stepped, thereby forming a first step, and a first flange extending toward an adjacent floor member among the plurality of floor members is formed at another end of the at least one first member; and
the second member is upwardly partially recessed at one end thereof to be stepped, thereby forming a second step, and a second flange extending toward an adjacent floor member among the plurality of floor members is formed at another end of the second member.

13. The underbody according to claim 12, wherein:
the at least one first member includes a plurality of first members continuously disposed in the longitudinal direction of the vehicle;
the first step of one of adjacent ones of the plurality of first members and the first flange of another one of the adjacent first members are welded to each other through friction stir welding under a condition that the first step and the first flange surface-contact each other; and
the second step of the second member and the first flange of one of the first members adjacent thereto are welded to each other through friction stir welding under a condition that the second step and the first flange surface-contact each other or the first step of another one of the first members and the second flange of the second member adjacent thereto are welded to each other through friction stir welding under a condition that the first step and the second flange surface-contact each other.

14. The underbody according to claim 13, wherein:
the floor members further comprise a third member and a fourth member each comprising a vertical barrier wall having a downwardly-extending end; and
the third member is upwardly partially recessed at one end thereof to be stepped, thereby forming a third step, and the fourth member is formed, at another end thereof, with a fourth flange extending toward one of the floor members adjacent thereto.

15. The underbody according to claim 14, wherein:
the second member is provided in plural;
the third step of the third member and the second flange of one second member adjacent thereto are welded to each other through friction stir welding under a condition that the third step and the second flange surface-contact each other; and
the fourth flange of the fourth member and the second step of another second member adjacent thereto are welded to each other through friction stir welding under a condition that the fourth flange and the second step surface-contact each other.
